(19) United States
(12) Patent Application Publication
(10) Pub. No.: US 2005/0042164 A1
(43) Pub. Date: Feb. 24, 2005

(54) Carbon blacks having improved colloidal and morphological properties, methods for manufacture, and uses thereof

(76) Inventors: Marcia D. Kennedy, Woodstock, GA (US); Romeo A. Baccay, Acworth, GA (US)

Correspondence Address: NEEDLE & ROSENBERG, P.C., SUITE 1000, 999 PEACHTREE STREET, ATLANTA, GA, 30309-3915, US

(21) Appl. No.: 10/647,048

(22) Filed: Aug. 22, 2003

(51) Int. Cl. C09C 1/48

(52) U.S. Cl. 423/449.1

(57) ABSTRACT

The present invention is directed to carbon blacks comprising improved colloidal and morphological properties. Additionally, the present invention is further directed to various methods for the manufacture of the inventive carbon blacks described herein as well as uses for same.

### FIELD OF THE INVENTION

The present invention relates generally to carbon black and improved morphological and colloidal properties thereof.

### BACKGROUND OF THE INVENTION

Carbon blacks, and more specifically, aqueous carbon black dispersions are commonly used for the production of printing inks, for example, as inks used in inkjet printers. The inkjet printing process itself is a known reproduction method in which the printing ink is transferred without pressure, i.e. without the print head coming into contact with the print medium. In this process, ink drops are sprayed from a nozzle onto a receiving material.

A characteristic of these aqueous dispersions of carbon black pigment is that they typically assume the form of agglomerates of multiple primary aggregates. If these pigment agglomerates are insufficiently finely dispersed, they can result in settling and ultimately clogging of the inkjet print head nozzles. Moreover, large agglomerates adversely modify the light absorption characteristics of the pigment black, resulting in greyer prints and a reduction of covering power.

Therefore, there is a need in the art of carbon black and aqueous compositions comprising carbon black to develop carbon blacks with specific colloidal and morphological properties that can provide desired performance qualities when used in aqueous compositions and also maintain the necessary processibility and dispersion stability to remain useful in inkjet applications and related equipment. To that end, it is an object of the present invention to provide carbon blacks that can provide a sufficiently low level of agglomeration when used in an aqueous composition and still maintain a superior optical density with desirable blue undertone.

### SUMMARY OF THE INVENTION

Among other aspects, the present invention is based upon the surprising discovery of improved carbon blacks that exhibit improved colloidal and morphological properties as well as improved combinations thereof.

In a first aspect, the present invention provides a carbon black comprising an ASTM D2412 measured dibutyl phthalate absorption number greater than 165 cc/100 grams of carbon black; and an ASTM D3849 measured mean particle size less than 20 nm.

In a second aspect, the present invention provides a carbon black comprising an ASTM D2412 measured dibutyl phthalate absorption number greater than 155 cc/100 grams of carbon black; and an ASTM D3849 measured mean particle size less than 16 nm.

In a third aspect, the present invention provides a process for the manufacture of the carbon blacks disclosed herein, comprising the steps of combusting an oxidant and a fuel in a combustor section of a carbon black reactor to provide at least one combustion gas, wherein the oxidant and fuel are introduced into the combustor section at a relative oxidant/fuel ratio in the range of from approximately 14 to 22 Nm³/Nm³; injecting a carbonaceous feedstock into a choke section of the carbon black reactor, wherein the carbonaceous feedstock is injected at an air/carbonaceous feedstock ratio in the range of from approximately 4 to approximately 8 Nm³/kg; and reacting the carbonaceous feedstock with the at least one combustion gas in the reactor under conditions effective to provide the carbon blacks of the present invention.

In a fourth aspect, the invention comprises a product made by the inventive processes described herein.

In still a fifth aspect, the present invention comprises an aqueous composition comprising water and the inventive carbon black as mentioned above.

Additional advantages of the invention will be obvious from the description, or may be learned by practice of the invention. Additional advantages of the invention will also be realized and attained by means of the elements and combinations particularly pointed out in the appended claims. Therefore, it is to be understood that both the foregoing general description and the following detailed description are exemplary and explanatory of certain embodiments of the invention, and are not restrictive of the invention as claimed.

### BRIEF DESCRIPTION OF THE FIGURES

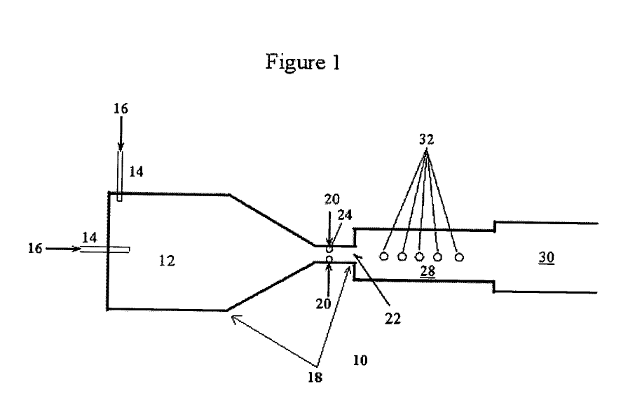

The appended FIG. 1, which is incorporated in and constitutes part of the specification, illustrates a schematic view of a carbon black reactor used to manufacture the carbon blacks of the present invention.

### DETAILED DESCRIPTION OF THE INVENTION

The present invention may be understood more readily by reference to the following detailed description and any examples provided herein. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular forms “a,” “an,” and “the” comprise plural referents unless the context clearly dictates otherwise. For example, reference to a component in the singular is intended to comprise a plurality of components.

Ranges may be expressed herein as from “about” or “approximately” one particular value and/or to “about” or “approximately” another particular value. When such a range is expressed, another embodiment comprises from the one particular value and/or to the other particular value. Similarly, when values are expressed as approximations, by use of the antecedent “about,” it will be understood that the particular value forms another embodiment.

As used herein, a weight percent of a component, unless specifically stated to the contrary, is based on the total weight of the formulation or composition in which the component is included.

As used herein, by use of the term “effective,” “effective amount,” or “conditions effective to” it is meant that such amount or reaction condition is capable of performing the function of the compound or property for which an effective amount is expressed. As will be pointed out below, the exact amount required will vary from one embodiment to another, depending on recognized variables such as the compounds employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, a “typical” or “conventional” carbon black reactor has separate combustion and reaction sections. More specifically, a conventional carbon black reactor comprises, in open communication and in the following order from upstream to downstream a combustion section, wherein the combustion section comprises at least one inlet for introducing a combustion feedstock; a choke section, wherein the choke section comprises at least one inlet, separate from the combustion section inlet, for introducing a carbonaceous feedstock and wherein the choke section converges toward a downstream end, said downstream end having a minimum cross sectional area; a quench section, having a minimum cross sectional area, wherein the quench section comprises at least one inlet, separate from the combustion section and choke section inlets, for introducing a quench material; and a breeching section. Additionally, in a conventional carbon black reactor, the ratio of the quench section minimum cross sectional area to the choke section minimum cross sectional area is greater than or equal to 1.5.

As used herein, the term “dibutyl phthalate absorption number,” or “DBPA” refers to a measurement of the relative structure of carbon black by determining the amount of dibutyl phthalate a given mass of carbon black can absorb. As used herein, the DBPA for the carbon blacks of the instant invention is measured in accordance with the ASTM D2412 testing method.

As used herein, the term “oxidant” refers to any gaseous material that can react with a fuel to produce combustion. An example of an oxidant suitable for use in the present invention includes, without limitation, oxygen contained in air.

The carbon blacks of the present invention advantageously provide several improved colloidal and morphological properties. These improved colloidal and morphological properties transcend into advantageous performance properties when the carbon blacks of the present invention are utilized in various end use applications. While these performance properties can be measured in a variety of end use compositions, the carbon blacks of the instant invention are particularly well suited for aqueous compositions, including aqueous dispersions, and more specifically, aqueous dispersions for use in the ink jet industry.

Among the improved colloidal and morphological properties provided by the carbon blacks of the present invention are improvements in the dibutyl phthalate absorption number (DBPA), mean particle size, and weight mean aggregate size.

The first of these improved morphological properties is the DBPA number which measures the structure or degree of aggregation of a carbon black. More specifically, the DBP absorption test measures the relative structure of carbon black by determining the amount of dibutyl phthalate a given mass of carbon black can absorb before becoming a specified viscous paste. Accordingly, in one aspect, the carbon blacks of the present invention advantageously provide a dibutyl phthalate absorption number greater than approximately 155 cc/100 grams of carbon black, up to and including a dibutyl absorption number of approximately 200 cc/100 grams of carbon black. Additional DBPA values measured for the carbon blacks of the present invention include such values as greater than approximately 160 cc/100 grams of carbon black, greater than approximately 165 cc/100 grams of carbon black, greater than approximately 170 cc/100 grams of carbon black, greater than approximately 175 cc/100 grams of carbon black, greater than approximately 180 cc/100 grams of carbon black, greater than approximately 185 cc/100 grams of carbon black, greater than approximately 190 cc/100 grams of carbon black, and greater than approximately 195 cc/100 grams of carbon black. Moreover, in still another aspect, the carbon blacks of the present invention have DBPA numbers in the range of from a lower limit selected from greater than approximately 155, 160, 165, 170, 175, 180, 185, 190, or 195 cc/100 grams of carbon black up to an upper limit selected from approximately 160, 165, 170, 175, 180, 185, 190, 195 or 200 cc/100 grams of carbon black.

A second improved morphological property of the carbon blacks of the present invention is their mean particle sizes as measured by ASTM D3849. Accordingly, in one aspect, the carbon blacks of the present invention have a particle size less than approximately 20 nm and as small as approximately 8 nm. Additional particle sizes measured for the carbon blacks of the present invention include such values as less than approximately 19 nm, less than approximately 18 nm, less than approximately 17 nm, less than approximately 16 nm, less than approximately 15 nm, less than approximately 14 nm, less than approximately 13 nm, less than approximately 12 nm, less than approximately 11 nm, less than approximately 10 nm, and less than approximately 9 nm. Moreover, in still another aspect, the carbon blacks of the present invention have particle size measurements in the range of from an upper limit of less than approximately 20 nm, 19 nm, 18 nm, 17 nm, 16 nm, 15 nm, 14 nm, 13 nm, 12 nm, 11 nm, 10 nm or 9 nm to a lower limit of approximately 19 nm, 18 nm, 17 nm, 16nm, 15 nm, 14nm, 13nm, 12nm, 11 nm, 10 nm,9nm,or8 nm.

A third improved morphological property of the carbon blacks of the present invention is the weight mean aggregate sizes as measured by ASTM D3849. Accordingly, in one aspect, the carbon blacks of the present invention have a weight mean aggregate size in the range of from approximately 50 nm to approximately 750 nm, including such weight mean aggregate sizes as 100, 150, 200, 250, 300, 350, 400, 450, 500, 550, 600, 650 and 700 nm. Moreover, in still another aspect, the carbon blacks of the present invention have weight mean aggregate size measurements in the range of from approximately 170 nm to approximately 190 nm, including such specific values as 171, 172, 173, 174, 175, 176, 177, 178, 179, 180, 181, 182, 183, 184, 185, 186, 187, 188, and 189 nm.

In addition to the individual improvements in morphological properties as set forth above, the carbon blacks of the present invention further provide novel combinations of these improvements. For example, the carbon blacks of the present invention advantageously provide the combination of relatively high structure carbon blacks, as determined by the DBPA number, in combination with a relatively small particle size.

In one aspect, the present invention provides carbon blacks having a DBPA number greater than 165 cc/100 grams of carbon black, in combination with a particle size less than 20 nm. In accordance with this aspect, the DBPA number can again be any value or any range of values greater than 165 cc/100 grams of carbon black as set forth above. Likewise, the mean particle size can be any value or range of values less than 20 nm as set forth above. To that end, in a preferred sub-aspect, the present invention provides a carbon black having a DBPA number greater than approximately 173 cc/100 grams of carbon black and a particle size less than approximately 16 nm. Alternatively, in a more preferred sub-aspect, the present invention provides a carbon black having a DBPA number of approximately 180 cc/100 grams of carbon black and a mean particle size of approximately 14 nm.

In still another aspect, the present invention provides carbon blacks having a DBPA number greater than 155 cc/100 grams of carbon black, in combination with a particle size less than 16 nm. In accordance with this aspect, the DBPA number can again be any value or any range of values greater than 155 cc/100 grams of carbon black as set forth above. Likewise, the mean particle size can be any value or range of values less than 16 nm as set forth above.

In an alternative aspect, the present invention provides a process for the manufacture of a carbon black having the improved colloidal and/or morphological properties or combination of properties as previously described herein.

In one sub-aspect the process comprises the steps of combusting an oxidant and a fuel in a combustor section of a carbon black reactor to provide at least one combustion gas; injecting a carbonaceous feedstock into a choke section of the carbon black reactor; and reacting the carbonaceous feedstock with the at least one combustion gas under conditions effective to provide a carbon black comprising an ASTM D2412 measured dibutyl phthalate absorption number greater than 165 cc/100 grams of carbon black and an ASTM D3849 measured mean particle size less than 20 nm.

In a second sub-aspect, the process comprises the steps of combusting an oxidant and a fuel in a combustor section of a carbon black reactor to provide at least one combustion gas; injecting a carbonaceous feedstock into a choke section of the carbon black reactor; and reacting the carbonaceous feedstock with the at least one combustion gas under conditions effective to provide a carbon black comprising an ASTM D2412 measured dibutyl phthalate absorption number greater than 155 cc/100 grams of carbon black and an ASTM D3849 measured mean particle size less than 16 nm.

According to the process of the present invention, conditions effective to provide a desired carbon black can include, without limitation, specific reactor and/or process conditions that can be modified in order to optimize a carbon black having desired morphological and colloidal properties. These conditions can include, but are not limited to, the air to oil ratio of the reactor, the air to natural gas ratio, the residence time within the reactor, temperature, the position of the make oil sprays relative to the down stream end of the choke, and the use of a fluid energy mill to further process the carbon black product collected at the downstream end of the reactor.

According to the process of the present invention, one aspect provides a process for the manufacture of a carbon black wherein the conditions effective to provide a carbon black comprise introducing the conversion oil and air into a choke section of a reactor at an air/oil ratio in the range of from approximately 4 Nm³/kg to approximately 8 Nm³/kg, including such ratios as 5, 6 and 7 Nm³/kg.

In another aspect of the present process, a condition effective to provide a carbon black comprises introducing a natural gas fuel and air into a combustor section of a reactor at an air (Nm³)/natural gas (Nm³) ratio of approximately from 14 to approximately 22, including such values as approximately 15, 16, 17, 18, 19, 20 and 21.

In still another aspect of the present invention, process conditions effective to provide a carbon black of the present invention include, without limitation, configuring a reactor such that the average residence time of the carbon black particles within the reactor is in the range of from approximately 14 to approximately 19 milli-seconds, including such residence times as approximately 14.5, 15.0, 15.5, 16.0, 16.5, 17.0, 17.5, 18.0, and 18.5 milli-seconds.

Suitable reactor temperatures for the process of the present invention include, without limitation, any temperature within the range of from approximately 1350 degrees C to approximately 1850 degrees C, including such temperatures as 1400, 1450, 1500, 1550, 1600, 1650, 1700, 1750, and 1800 degrees C.

Suitable make oil spray locations for the process of the present invention include, without limitation, any position in the range of from approximately 20 inches to approximately 26 inches upstream from the downstream end of the choke. This can include such additional make oil spray locations as 21, 22, 23, 24 or 25 inches upstream from the downstream end of the choke section.

Suitable carbonaceous feedstocks for use in the process of the present invention are preferably feedstocks having a relatively high BMCI (Bureau of Mines Correlation Index). To this end, preferable feedstocks or oils include those having a BMCI value of at least 130, including such carbonaceous feedstocks as BMCI 135 oil, BMCI 140 oil, and BMCI 145 oil.

It should also be understood that the carbon blacks set forth herein and manufactured by the processes described herein, can be further oxidized as a means to improve or further enhance the wettability and dispersibility of these carbon blacks in aqueous dispersions, and more specifically, in inkjet applications, without diminishing the advantageous morphological and colloidal properties described above. Accordingly, several oxidation processes can also be applied to oxidize the carbon black. Among the preferred methods are, without limitation, ozonation, air oxidation and oxidation with strong oxidizing agents such as nitric acid, persulfates, trifluoroperacetic acid and the like.

For example, in one aspect, a gas phase oxidation of the carbon black can include, without limitation, the ozonation of the carbon black in a rotary drum bed. This process comprises the use of a central sparger positioned within a rotary drum that blows ozone through a stream of carbon black that is continuously fed into the rotating drum. Alternatively, a gas phase ozone oxidation process can comprise the injection of ozone through a column of carbon black fluidized in a vertical column by air and ozone that are fed into the bottom of the column. In accordance with these and other conventional oxidation methods, the oxidized carbon blacks of the present invention contain an oxygen content in the range of from approximately 5 weight % to approximately 10 weight %, including additional oxygen content values of approximately 6 wt. %, 7 wt. %, 8 wt. % and 9 wt. % (as measured by any conventional combustion technique known to one of ordinary skill in the art), whereas an unoxidized carbon black of the present invention contains, in one aspect, an oxygen content of approximately 1.2 weight %.

Although the process of the present invention has been described in connection with certain preferred reactor conditions, it will be appreciated by one of ordinary skill in the art in view of this disclosure that such conditions can be modified and optimized to provide a carbon black having the desired combination of morphological and colloidal properties. Moreover, these modifications and optimizations will be readily apparent or achieved through no more than routine experimentation.

With specific reference to the appended FIG. 1, a carbon black reactor 10 for producing a carbon black of this invention is disclosed. The reactor 10 for producing carbon black comprises, in open communication and in the following order from upstream to downstream a combustion section 12, wherein the combustion section comprises at least one inlet 14 for introducing a combustion feedstock 16; a choke section 18, wherein the choke section comprises at least one inlet 24, separate from the combustion section inlet, for introducing a carbonaceous feedstock 20 and wherein the choke section converges toward a downstream end 22, said downstream end having a minimum cross sectional area; a quench section 28, having a minimum cross sectional area, wherein the quench section comprises at least one inlet 32, separate from the combustion section and choke section inlets, for introducing a quench material; and a breeching section 30.

The four sections described above need not be physically separate or distinct components, but may be different functional areas within a single formed component. Moreover, it should be understood that the reactor 10 can comprise additional sections, but the above sections would remain in their same order relative to each other from upstream to downstream.

In still another aspect, the present invention provides various end use applications for the carbon blacks described herein. To that end, the carbon blacks of the instant application are particularly well suited for use in waterborne systems, such as aqueous pigment dispersions, waterborne architectural and automotive coatings and waterborne conventional and digital ink formulations. Use of these carbon blacks in waterborne systems offers improved performance characteristics such as processibility, dispersion stability and overall dispersion quality.

As stated above, the carbon blacks of the present invention provide improved performance properties when compared to their conventional counterparts. To that end, it has been discovered that the carbon blacks of the present invention provide a superior quality dispersion when dispersed in an aqueous composition. Accordingly, the relative quality of a dispersion can be illustrated by a comparison of the agglomerate size of a carbon black in an aqueous dispersion to the mean aggregate size of a dry carbon black. As used herein, the ratio of the agglomerate size of the carbon black in an aqueous dispersion, as measured by a Microtrac UPA 250 particle size analyzer at 50% pass, to the weight mean aggregate size of the dry carbon black, as measured by ASTM D3849, is referred to as the “dispersion quality index.” The closer the ratio is to a value of one (1), the better the quality of the dispersion.

For purposes of the present invention, the mean agglomerate size of the carbon black in an aqueous dispersion is obtained through the use of a Microtrac UPA 250 Particle Size Analyzer at 50% pass. Additionally, the tests were performed on an aqueous dispersion having the formulation illustrated below in Table 1. The formulation was first milled for 16 hours on a LAU shaker using approximately 460 grams of 3/32 inch diameter stainless steel shot.

TABLE 1

| INGREDIENT | WEIGHT PERCENT |
|---|---|
| Borchigen SN 95 | 29.4% |
| Distilled Water | 15.0% |
| Carbon Black | 10.0% |
| Byk 021 | 1.0% |
| Propylene Glycol | 11.2% |
| Neocryl A-5090 | 33.4% |

When tested in the formulation set forth above, the carbon black of the present invention provides a mean aggregate size in an aqueous dispersion in the range of from approximately 165 nm to approximately 180 nm, including such additional mean aggregate sizes as 166, 167, 168, 169, 170, 171, 172, 173, 174, 175, 176, 177, 178 and 179 nm.

Accordingly, the carbon blacks of the present invention provide a “dispersion quality index” in the range of from approximately 0.90 to approximately 1.20, including such additional dispersion quality index values as 0.95, 1.0, 1.05, 1.10, and 1.15. It should be understood that these measurements will have an inherent margin of error due to several factors such as dispersion preparation, sampling technique, instrumentation, state and nature of sample which could affect the degree of reproducibility of the experimentation and the inherent bias between the two different measurements used to arrive at the dispersion quality index. Therefore, although a dispersion quality index value of 1.0 is a theoretical value, it is to be expected that values less than 1.0 may also be achieved.

In addition to the mean aggregate size of the carbon black aggregates dispersed within aqueous compositions, the carbon blacks of the present invention also advantageously provide relatively few oversized agglomerates when dispersed in aqueous compositions. Reduction of oversized agglomerate count is particularly significant for aqueous dispersions intended for use in inkjet applications as it is necessary to avoid the clogging of the inkjet printhead nozzle. For purposes of the present disclosure, an oversized agglomerate refers to agglomerates of carbon black particles that are greater than approximately 0.5 microns in size. Furthermore, for purposes of the present invention, the oversized agglomerate count is determined using a Model 780 Accusizer, and is also referred to as an “Accusizer count.” Referring again to the formulation set forth in Table 1 and discussed above, the carbon blacks of the present invention advantageously provide Accusizer counts in the range of from 1.5×10⁹/ml to 2.5×10⁹/ml, including such values as approximately 1.6, 1.7, 1.8, 1.9, 2.0, 2.1, 2.2, 2.3, and 2.4×10⁹/ml. These values can be obtained according to the following sample preparation and procedure. First, 200 μl (micro-liters) of the initial pigment dispersion, as set forth in Table 1, is diluted in 500 ml of deionized water. Then, 5 ml of the diluted dispersion is injected into the Accusizer's autodiluter. The volume of the injected pre-diluted dispersion and its solids concentration are then input into the Volume Fraction Sample Calculation option of the Accusizer. The total number of oversized particles per ml greater than 0.5 μm are then recorded to reflect the concentration of particles per ml of the diluted dispersion and then adjusted to the initial pigment dispersion solids level.

Additional performance enhancements also include improvements in Hunter “b” masstone values of aqueous dispersions comprising the carbon blacks of the present invention. Accordingly, in one aspect, aqueous dispersions comprising the carbon black of the present invention have Hunter “b” masstone values in the range of from less than or equal to approximately −3.00 to a lower limit of approximately −4.00, including such additional values and ranges as less than approximately −3.10, −3.20, −3.30, −3.40, −3.50, −3.60, −3.70, −3.80 and −3.90.

When the carbon blacks of the present invention are utilized in an aqueous dispersion, the carbon black can be present in an amount of from approximately 1 wt % to approximately 40 wt. % relative to the entire aqueous dispersion, including additional weight percentages of 5 wt. %, 10 wt. %, 15 wt. %, 20 wt. %, 25 wt. %, 30 wt. % and 35 wt. %. In a preferred embodiment, the dispersion comprises in the range of from approximately 5 wt. % to approximately 40 wt. % of carbon black.

The aqueous formulations according to the present invention can also comprise one or more dispersants. For example, preferable dispersants include polyurethane resin dispersants, such as Borchigen SN 95 (available from the Bayer Corporation); polyamide dispersants such as any one or more of the Solsperse series of hyper-dispersants (available from Avecia, Manchester, United Kingdom), acrylic dispersants such as Nopcosperse dispersant and Joncryl dispersants from Henkel Corporation and S.C. Johnson Wax respectively, or hybrid acrylic-urethane dispersants. To this end, an aqueous dispersion according to these embodiments would also therefore preferably comprise a pigment to dispersant weight ratio in the range of from approximately 1.2 to approximately 5.0, including without limitation, additional weight ratios of 1.5, 2.0, 2.5, 3.0, 3.5, 4.0 and 4.5. It is also to be understood that the weight ratios set forth above are relative to the weight of active ingredient present within a given amount of dispersant used. For example, if a dispersant contained only 25% active ingredient, then the weight ratio of pigment to dispersant would be based on the actual weight of pigment to the actual weight of the dispersant active ingredient incorporated into a given formulation.

If desired, aqueous dispersions and formulations comprising the carbon blacks of the present invention can further comprise one or more humectants selected from, for example, ethylene glycol, diethylene glycol, propylene glycol, dipropylene glycol, polyethylene glycol, polypropylene glycol, alcohol derivatives such as ethanol, propanol, isopropanol and the like, and cellosolve. It will be appreciated that the humectant is introduced as a means to maintain a substantially constant moisture content of the aqueous dispersions and formulations.

Additionally, a waterborne formulation or dispersion according to the present invention can optionally contain one or more additional additives including without limitation, antifoaming agents such as Byk 021, available from Byk Chemie, Wesel, Germany); polymer binders and/or resin grind aids, such as Joncryl J-61 (an acrylic polymer, manufacture and available from S.C. Johnson Wax.) and/or Neocryl A-5090 (available from Neoresins, Inc., Waalwijk, The Netherlands); surfactants such as Surfynol 695 and/or Surfynol 7608 (both available from Air Products) and/or Aerosol OT (available from the Cytec Corporation, Inc.); and one or more biocide compositions.

It will be appreciated that the polymer binder acts as a film forming component allowing a formulation, such as an aqueous ink, to have substantial fastness and staying potential thus allowing the ink to bind to the substrate once water and other optional solvents have evaporated. The resin grind aid helps the dispersant in the grinding, milling and ultimate stabilization of the carbon black dispersion The incorporation of an optional biocide component, such as Proxel GXL (available from Avecia, Manchester, United Kingdom) may also be desired in order to control and/or prevent the potential growth of algae and other microorganisms, which are typically prone to develop in an aqueous system or formulation.

Additional water, not already present in any of the previously discussed stated components, e.g., dispersant, polymer binders, antifoaming agents and biocides, can also be added to the formulation such that the total aqueous content of a formulation is in the range of from approximately 15 weight % to approximately 60 weight %, including without limitation, additional weight percentages of 20%, 25%, 30%, 35%, 40%, 45%, 50% and 55%.

It will also be appreciated that the aqueous dispersions comprising the carbon blacks of the present invention can be prepared using any milling or dispersing machine known to one of ordinary skill in the art, including without limitation, shear stress machines such as shakers, ball mills, and pearl mills.

Other end use applications and corresponding advantages of the carbon blacks disclosed herein will be readily apparent to one of ordinary skill in the art. Moreover, the weight percent loading of carbon blacks capable of use in the above-mentioned applications will be similar to the amount of conventional carbon black presently used in similar formulations and will be readily obtainable by one of ordinary skill in the art through no more than routine experimentation.

### EXAMPLES

The following examples are put forth so as to provide those of ordinary skill in the art with a complete disclosure and description of how the inventive carbon black, methods and apparatuses for the manufacture thereof, and uses thereof described and claimed herein are made and evaluated. The examples are intended to be purely exemplary and are not intended to limit the scope of what the inventors regard as their invention. Efforts have been made to ensure accuracy with respect to numbers (e.g., amounts, temperature, etc.) but some errors and deviations should be accounted for. There are numerous variations and combinations of reaction conditions that can be used to optimize the product purity and yield obtained from the described process. Accordingly, only reasonable and routine experimentation will be required to optimize such process conditions.

### Example I

### Preparation of the Improved Carbon Black

A carbon black according to the present invention was manufactured in a carbon black reactor as previously described herein and as illustrated by FIG. 1.

In a first step, preheated combustion air and natural gas fuel were mixed to produce a high temperature of approximately 1500 degrees C within the reactor's combustion zone. The reactor conditions were adjusted such that the Air/Natural Gas ratio was approximately 19.8 and the residence time within the reactor was approximately 17.6 milliseconds. The make oil sprays were positioned approximately 26 inches upstream from the downstream end of the choke and a 142 BMCI liquid hydrocarbon feedstock, commonly known as conversion oil, was then injected into the reaction zone of the reactor where it at least partially burned and partially cracked (dehydrogenated) to form the carbon black product. The conversion oil rate was set at an air to oil ratio of 7 Nm³/kg. Upon completion of the cracking reaction, the process gas stream was quenched and cooled by direct injection of water. After the process gases were cooled by direct injection of water to a temperature of approximately 925 degrees C or cooler, the process gases were then passed through an air/gas heat exchanger. Once having passed through the exchanger, the process gases were further cooled to a temperature in the range of from 240 degrees C to 290 degrees C by an additional series of water sprays.

Downstream from the heat exchanger, the process gases were then passed through a series of bag collectors containing several modules consisting of fiberglass cloth bags suspended along the length of the module. The carbon black product present within the process gases collected on the outside of the fiberglass cloth bags. Once collected, the carbon black was dislodged from the fiberglass cloth bags by a pulse of high pressure air and allowed to drop into a hopper section of modules.

The carbon black was then passed through a fluid energy mill, for this example, a Sturdivant fluid energy mill was used.

The final milled carbon black was then tested in two parallel experiments for DBPA, mean particle size and weight mean aggregate size, the results of which are set forth in Table 2 below as samples A and B respectively.

TABLE 2

| Test | Sample A | Sample B |
|---|---|---|
| DBPA (cc/100 grams) | 174 | 182 |
| Mean Particle Size (nm) | 13.1 | 13.3 |
| Weight Mean Aggregate Size (nm) | 179 | 182 |

### Example II

### Aqueous Dispersion Comprising the Carbon Black of Example I

An aqueous dispersion comprising the carbon black prepared in Example I was prepared using the following formulation.

| INGREDIENT | WEIGHT PERCENT |
|---|---|
| Borchigen SN 95 | 29.4% |
| Distilled Water | 15.0% |
| Carbon Black of Example I | 10.0% |
| Byk 021 | 1.0% |
| Propylene Glycol | 11.2% |
| Neocryl A-5090 | 33.4% |

First, the Borchigen and distilled water were mixed into a stainless steel shaker jar. The carbon black was then manually mixed into the shaker jar using a metal spatula until all the carbon black powder was wetted down. After the addition of the carbon black was completed, 460 grams of 3/32 inch stainless steel shot media were added to the shaker jar. Next, the Byk 021 was added and the mixture was swirled with a mini-spatula until the foam subsided. Finally, the propylene glycol and the Neocryl A-5090 were added to the shaker jar and the jar was capped. The shaker jar was then placed on a LAU shaker for 16 hours, after which time the mill was discharged and the resulting dispersion was tested twice in parallel experiments for Accusizer count, Microtrac Aggregate size, Hunter “b” masstone and the “dispersion quality index,” the results of which are set forth in Table 3 below for Samples A and B respectively.

TABLE 3

| Test | Sample A | Sample B |
|---|---|---|
| Accusizer Count | 1.91 × 10⁹/ml | 2.01 × 10⁹/ml |
| Microtrac Aggregate Size | 173 nm | 170 nm |
| Hunter “b” value | −3.31 | −3.22 |
| Dispersion Quality Index | 0.97 | 0.93 |

While certain representative embodiments and details have been shown for the purpose of illustrating the invention, it will be apparent to those skilled in this art that various changes and modifications may be made therein without departing from the spirit or scope of the invention.

1. A carbon black, comprising:
a) an ASTM D2412 measured dibutyl phthalate absorption number greater than 165 cc/100 grams of carbon black; and
b) an ASTM D3849 measured mean particle size less than 20 nm.

2. The carbon black of claim 1, wherein the dibutyl phthalate absorption number is greater than approximately 170 cc/100 grams of carbon black.

3. The carbon black of claim 1, wherein the dibutyl phthalate absorption number is greater than approximately 175 cc/100 grams of carbon black.

4. The carbon black of claim 1, wherein the dibutyl phthalate absorption number is approximately 180 cc/100 grams of carbon black.

5. The carbon black of claim 1, wherein the mean particle size is less than approximately 19 nm.

6. The carbon black of claim 1, wherein the mean particle size is less than approximately 18 nm.

7. The carbon black of claim 1, wherein the mean particle size is less than approximately 16 nm.

8. The carbon black of claim 1, wherein the mean particle size is approximately 14 nm.

9. The carbon black of claim 1, wherein the dibutyl phthalate absorption number is greater than approximately 173 cc/100 grams of carbon black and wherein the mean particle size is less than approximately 16 nm.

10. The carbon black of claim 1, wherein the dibutyl phthalate absorption number is approximately 180 cc/100 grams of carbon black and wherein the mean particle size is approximately 14 nm.

11. The carbon black of claim 1, wherein the carbon black is an oxidized carbon black having an oxygen content in the range of from approximately 5 weight % to approximately 10 weight %.

12. A carbon black for use in inkjet compositions, comprising:
a) an ASTM D2412 measured dibutyl phthalate absorption number greater than 155 cc/100 grams of carbon black; and
b) an ASTM D3849 measured mean particle size less than 16 nm.

13. The carbon black of claim 12, wherein the dibutyl phthalate absorption number is greater than approximately 160 cc/100 grams of carbon black.

14. The carbon black of claim 12, wherein the dibutyl phthalate absorption number is greater than approximately 165 cc/100 grams of carbon black.

15. The carbon black of claim 12, wherein the dibutyl phthalate absorption number is greater than approximately 170 cc/100 grams of carbon black.

16. The carbon black of claim 12, wherein the dibutyl phthalate absorption number is greater than approximately 175 cc/100 grams of carbon black.

17. The carbon black of claim 12, wherein the dibutyl phthalate absorption number is approximately 180 cc/100 grams of carbon black.

18. The carbon black of claim 12, wherein the mean particle size is less than approximately 15 nm.

19. The carbon black of claim 12, wherein the mean particle size is approximately 14 nm.

20. The carbon black of claim 12, wherein the dibutyl phthalate absorption number is greater than approximately 173 cc/100 grams of carbon black and wherein the mean particle size is less than approximately 16 nm.

21. The carbon black of claim 12, wherein the dibutyl phthalate absorption number is approximately 180 cc/100 grams of carbon black and wherein the mean particle size is approximately 14 nm.

22. The carbon black of claim 12, wherein the carbon black is an oxidized carbon black having an oxygen content in the range of from approximately 5 weight % to approximately 10 weight %.

23. A process for the manufacture of a carbon black, comprising the steps of:
a) combusting an oxidant and a fuel in a combustor section of a carbon black reactor to provide at least one combustion gas, wherein the oxidant and fuel are introduced into the combustor section at a relative oxidant/fuel rate in the range of from approximately 14 to 22 Nm³/Nm³;
b) injecting a carbonaceous feedstock into a choke section of the carbon black reactor, wherein the carbonaceous feedstock is injected at an air/carbonaceous feedstock ratio in the range of from approximately 4 to approximately 8 Nm³/kg; and
c) reacting the carbonaceous feedstock with the at least one combustion gas in the reactor under conditions effective to provide a carbon black comprising an ASTM D2412 measured dibutyl phthalate absorption number greater than 165 cc/100 grams of carbon black and an ASTM D3849 measured mean particle size less than 20 nm.

24. The process of claim 23, wherein the conditions effective of step c) comprise heating the reactor to a temperature in the range of from approximately 1350 to approximately 1850 degrees C.

25. The process of claim 23, wherein the conditions effective of step c) comprise a residence time of the carbon black within the reactor in the range of from approximately 14 to approximately 19 milli-seconds.

26. The process of claim 23, wherein the carbonaceous feedstock of step b) is introduced into the reactor through at least one make oil spray located in the range of from approximately 20 to approximately 26 inches upstream from a downstream end of the choke section.

27. The process of claim 23, wherein the carbonaceous feedstock of step b) is an oil having a BMCI value of at least 130.

28. The process of claim 23, wherein the conditions effective of step c) comprise passing the carbon black through a fluid energy mill.

29. The process of claim 23, wherein the carbonaceous feedstock of step b) is an oil having a BMCI value of at least 130 and is introduced into the reactor through at least one make oil spray located in the range of from approximately 20 to approximately 26 inches upstream from a downstream end of the choke section; and wherein the conditions effective of step c) comprise: (i) heating the reactor to a temperature in the range of from approximately 1350 to approximately 1850 degrees C; (ii) a residence time of the carbon black within the reactor in the range of from approximately 14 to approximately 19 milli-seconds; and (iii) passing the carbon black through a fluid energy mill.

30. A process for the manufacture of a carbon black, comprising the steps of:
a) combusting an oxidant and a fuel in a combustor section of a carbon black reactor to provide at least one combustion gas, wherein the oxidant and fuel are introduced into the combustor section at a relative oxidant/fuel rate in the range of from approximately 14 to 22 Nm³/ Nm³;
b) injecting a carbonaceous feedstock into a choke section of the carbon black reactor, wherein the carbonaceous feedstock is injected at an air/carbonaceous feedstock ratio in the range of from approximately 4 to approximately 8 Nm³/kg; and
c) reacting the carbonaceous feedstock with the at least one combustion gas in the reactor under conditions effective to provide a carbon black comprising an ASTM D2412 measured dibutyl phthalate absorption number greater than 155 cc/100 grams of carbon black and an ASTM D3849 measured mean particle size less than 16 nm.

31. The process of claim 30, wherein the conditions effective of step c) comprise heating the reactor to a temperature in the range of from approximately 1350 to approximately 1850 degrees C.

32. The process of claim 30, wherein the conditions effective of step c) comprise a residence time of the carbon black within the reactor in the range of from approximately 14 to approximately 19 milli-seconds.

33. The process of claim 30, wherein the carbonaceous feedstock of step b) is introduced into the reactor through at least one make oil spray located in the range of from approximately 20 to approximately 26 inches upstream from a downstream end of the choke section.

34. The process of claim 30, wherein the carbonaceous feedstock of step b) is an oil having a BMCI value of at least 130.

35. The process of claim 30, wherein the conditions effective of step c) comprise passing the carbon black through a fluid energy mill.

36. The process of claim 30, wherein the carbonaceous feedstock of step b) is an oil having a BMCI value of at least 130 and is introduced into the reactor through at least one make oil spray located in the range of from approximately 20 to approximately 26 inches upstream from a downstream end of the choke section; and wherein the conditions effective of step c) comprise: (i) heating the reactor to a temperature in the range of from approximately 1350 to approximately 1850 degrees C; (ii) a residence time of the carbon black within the reactor in the range of from approximately 14 to approximately 19 milli-seconds; and (iii) passing the carbon black through a fluid energy mill.

37. The product produced by the process of claim 23.

38. The product produced by the process of claim 30.

39. An aqueous composition comprising the carbon black of claim 1 and water.

40. The composition of claim 39, wherein the composition is an aqueous dispersion.

41. The composition of claim 39, further comprising a dispersant.

42. The composition of claim 39, further comprising an acrylic binder.

43. The composition of claim 39, further comprising an organic co-solvent.

44. The composition of claim 39, wherein the composition is an inkjet composition.

45. The composition of claim 39, wherein the composition exhibits a Hunter “b” value less than or equal to −3.00.

46. The composition of claim 39, wherein the composition exhibits a Hunter “b” value less than or equal to −3.10.

47. The composition of claim 39, wherein the composition exhibits a Hunter “b” value less than or equal to −3.20.

48. The composition of claim 39, wherein the composition exhibits a Hunter “b” value less than or equal to −3.30.

49. The composition of claim 39, wherein the composition has a dispersion quality index in the range of from approximately 0.9 to approximately 1.20

50. The composition of claim 49, wherein the dispersion quality index is in the range of from approximately 1.0 to approximately 1.10.
